(19) United States
(12) Patent Application Publication
(10) Pub. No.: US 2016/0157140 A1
(43) Pub. Date: Jun. 2, 2016

(54) Capability Handling After Inter Radio Access Technology Handover

(71) Applicant: NOKIA SOLUTIONS AND NETWORKS OY, Espoo (FI)

(72) Inventors: Bindhya Vashini TIWARI, Vantaa (FI); Guillaume DECARREAU, Munich (DE); Sheyam Lal DHOMEJA, Espoo (FI)

(21) Appl. No.: 14/905,556

(22) PCT Filed: Jul. 18, 2013
(86) PCT No.: PCT/EP2013/065228

§ 371 Date: Jan. 15, 2016

(51) Int. Cl. H04W 36/00

(52) U.S. Cl. CPC H04W 36/0055

(57) ABSTRACT

There are provided measures for capability handling after inter radio access technology handover. Such measures exemplarily include deciding whether mobile device capability information is to be transmitted, and transmitting, based on affirmative result of said deciding, said mobile device capability information.

### FIELD

The present invention relates to capability handling after inter radio access technology handover. More specifically, the present invention exemplarily relates to measures (including methods, apparatuses and computer program products) for realizing capability handling after inter radio access technology handover.

### BACKGROUND

The present specification generally relates to handover procedures in network deployments utilizing multiple radio access technologies (RAT). According to 3^{rd} Generation Partnership Project (3GPP) technical specification (TS) TS25.413 receives the Universal Terrestrial Radio Access Network (UTRAN) during handover from another RAT to the UTRAN radio access capability of a user equipment (UE) in an information element (IE) “Inter RAT Handover Info” in an IE “Source To Target Transparent Container” in a RELOCATION REQUEST. The UE capabilities included in the “Inter RAT Handover Info” IE comprise, among others, some of measurement capabilities of the UE and also multi RAT capabilities. UTRAN may use these advanced information during inter RAT handover procedure itself when allocating resources to the UE, and may use some of the capabilities later after the handover procedure is completed.

Even though the UE capabilities are transferred during the inter RAT handover, some of the capabilities have been omitted in the 3GPP standards from being transferred during the procedure. Accordingly, although not standardized, it is assumed that, in order to achieve all UE capabilities, UTRAN must always enquire UE radio access capability after the inter RAT handover procedure is completed. By demanding the UE capabilities explicitly, UTRAN can, after completion of the inter RAT handover procedure, achieve all the capabilities of the UE and use them when serving the UE.

It is noted that the above mentioned observations also apply to handover procedures between two different RATs (with UTRAN not being the target RAT), where “Inter RAT Handover Info” IE (or similar) is used to transfer the UE capabilities. Also the observations apply to intra RAT handover when UE moves from one radio access network to other in connected mode and UEs capabilities are to be transferred.

When receiving the UE capabilities in the “Inter RAT Handover Info” IE in the “Source To Target Transparent Container” IE in the RELOCATION REQUEST (according to TS 25.331), UTRAN is not aware as to whether all UE capabilities have been transferred to UTRAN or not. Namely, according to 3GPP specifications, capabilities which are missing in the “Inter RAT Handover Info” IE can be interpreted as that the UE does not support them, i.e., absence of IE means UE does not support the corresponding capability. This leads to ambiguity in the handling of the UE after the inter RAT handover.

In other words, the only available option at UTRAN is to always ask UE capabilities after relocation, without knowing if all the capabilities have been received already or not. Hence, UTRAN may perform UE capability enquiry after each inter RAT handover procedure is completed, and it then may receive the full capabilities of the UE.

However, when UTRAN does not know whether the full capabilities have been transferred or not during the inter RAT handover procedure, and thus always demands the full UE capabilities, then there is the risk that UTRAN may demand UE capability unnecessarily in case all capabilities would have been transferred already.

An unnecessary UE capability enquiry procedure, however, leads to extra signalling between the UE and the UTRAN after the inter RAT handover procedure which may increase the burden of both participants and the transmission path. Namely, such UE capability enquiry arises in addition to signalling which is be completed as soon as possible as well, i.e., UE-UTRAN signalling which is required to be performed after the inter RAT handover to UTRAN has been completed.

Hence, the problem arises that UE capabilities are not provided completely and reliably without additional signaling.

Hence, there is a need to provide for capability handling after inter radio access technology handover. In particular, there is a need for reliable provision of complete UE capabilities with reduced signaling effort.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising deciding whether mobile device capability information is to be transmitted, and transmitting, based on affirmative result of said deciding, said mobile device capability information.

According to an exemplary aspect of the present invention, there is provided a method comprising obtaining mobile device capability information, and determining whether said mobile device capability information is complete.

According to an exemplary aspect of the present invention, there is provided an apparatus comprising deciding means configured to decide whether mobile device capability information is to be transmitted, and transmitting means configured to transmit, based on affirmative result of said deciding, said mobile device capability information.

According to an exemplary aspect of the present invention, there is provided an apparatus comprising obtaining means configured to obtain mobile device capability information, and determining means configured to determine whether said mobile device capability information is complete.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient provision of complete UE capabilities to thereby solve at least part of the problems and drawbacks identified in relation to the prior art.

By way of exemplary embodiments of the present invention, there is provided capability handling after inter radio access technology handover. More specifically, by way of exemplary embodiments of the present invention, there are provided measures and mechanisms for realizing capability handling after inter radio access technology handover.

Thus, improvement is achieved by methods, apparatuses and computer program products enabling/realizing capability handling after inter radio access technology handover.

### BRIEF DESCRIPTION OF THE DRAWINGS

In the following, the present invention will be described in greater detail by way of non-limiting examples with reference to the accompanying drawings, in which

FIG. 1 shows a schematic diagram of signaling sequences related to communication of capability information,

FIG. 2 is a block diagram illustrating an apparatus according to exemplary embodiments of the present invention,

FIG. 3 is a block diagram illustrating an apparatus according to exemplary embodiments of the present invention,

FIG. 4 is a schematic diagram of a procedure according to exemplary embodiments of the present invention,

FIG. 5 is a schematic diagram of a procedure according to exemplary embodiments of the present invention,

FIG. 6 shows a schematic diagram of signaling sequences according to exemplary embodiments of the present invention,

FIG. 7 shows a schematic diagram of signaling sequences according to exemplary embodiments of the present invention,

FIG. 8 shows a schematic diagram of signaling sequences according to exemplary embodiments of the present invention,

FIG. 9 shows a schematic diagram of signaling sequences according to exemplary embodiments of the present invention, and

FIG. 10 is a block diagram alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, inter RAT handover to UTRAN is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) capability handling after inter radio access technology handover.

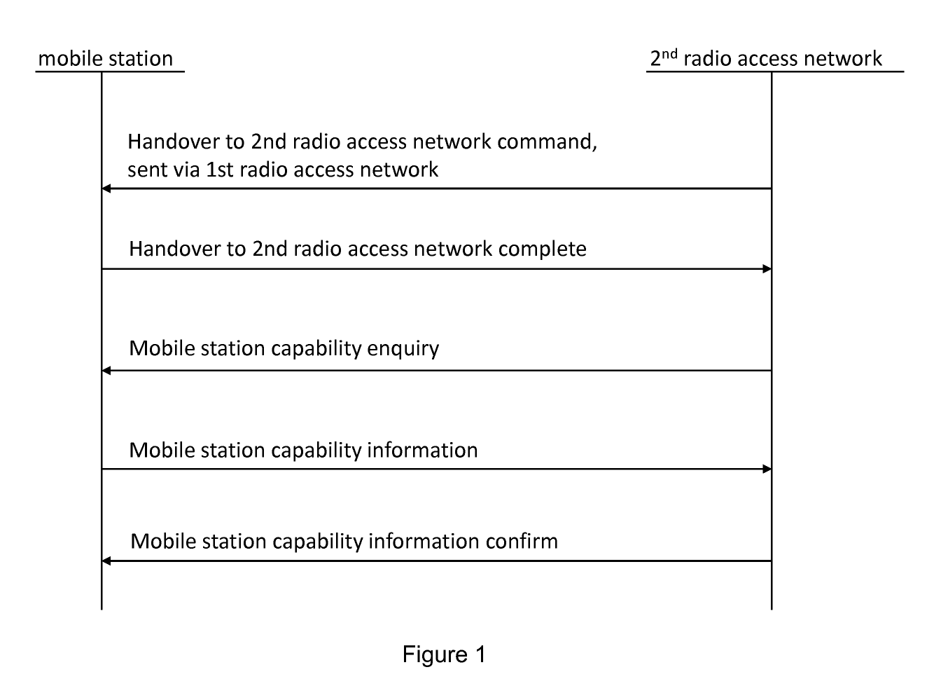

FIG. 1 shows a schematic diagram of signaling sequences related to communication of capability information.

As is shown, after a handover to an exemplary 2^{nd} RAT (i.e. handover target RAT) is completed (i.e., after communication of a handover complete message indicating that a handover initiated by a handover command message is finished), further signaling regarding UE capabilities is exchanged between the mobile station (i.e. UE) and the 2^{nd} RAT (i.e. radio network controller (RNC) of UTRAN).

According to 3GPP standards, when a RNC sends UE CAPABILITY ENQUIRY, the UE responds with UE CAPABILITY INFORMATION message. After receiving the response from the UE, UTRAN further sends a UE CAPABILITY INFORMATION CONFIRM message.

Consequently, three radio resource control (RRC) messages are required after each inter RAT handover to complete the capability enquiry procedure. Besides those messages related to UE capabilities, there is need to start integrity protection and intra and inter frequency measurements. Additionally, since only limited configuration can be given to the UE during the inter RAT handover procedure, UTRAN may need to switch the UE to a different configuration after inter RAT handover, but UTRAN must wait for the UE capability enquiry procedure to be completed.

In sum, besides further necessary signalling, a capability enquiry procedure delays handling of any new procedure in the UTRAN, which can in turn lead to a call drop and bad end user experience.

Exemplary embodiments of the present invention provide circumvention of such drawbacks. Namely, the extra signalling during the inter RAT handover procedure is reduced as there are lots of procedures which UTRAN must execute in sequence before it can configure UE to achieve high throughput based on its capability.

Namely, as described below, exemplary embodiments of the present invention provide approaches how UTRAN may receive the full Radio Access Capabilities of the UE after an inter RAT handover without need to always demand UE capabilities after each inter RAT handover.

Hence, exemplary embodiments optimise the signalling after an inter RAT handover. Thereby saved time and signalling may, according to exemplary embodiments of the present invention, thus be used to perform other procedures like switching UE to higher configuration for better throughput and end user experience.

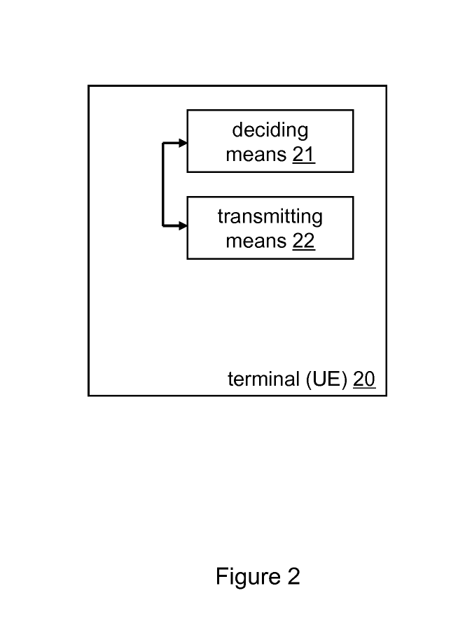

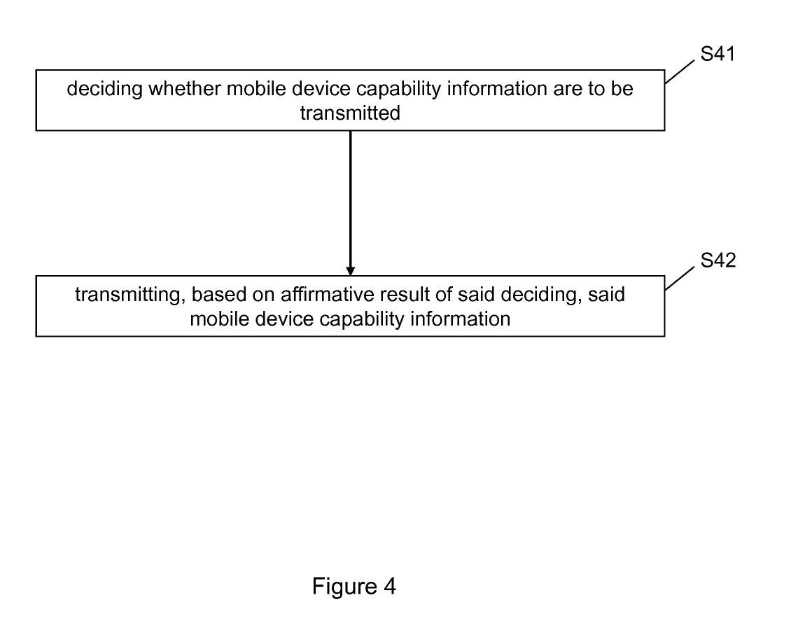

FIG. 2 is a block diagram illustrating an apparatus according to exemplary embodiments of the present invention. The apparatus may be a terminal such as a user equipment 20 comprising a deciding means 21 and a transmitting means 22. The deciding means 21 decides whether mobile device capability information is to be transmitted. The transmitting means transmits, based on affirmative result of said deciding, said mobile device capability information. FIG. 4 is a schematic diagram of a procedure according to exemplary embodiments of the present invention. The apparatus according to FIG. 2 may perform the method of FIG. 4 but is not limited to this method. The method of FIG. 4 may be performed by the apparatus of FIG. 2 but is not limited to being performed by this apparatus.

As shown in FIG. 4, a procedure according to exemplary embodiments of the present invention comprises an operation of deciding (S41) whether mobile device capability information is to be transmitted, and an operation of transmitting (S42), based on affirmative result of said deciding, said mobile device capability information.

According to exemplary embodiments of the present invention the UTRAN may be avoided to trigger UE capability enquiry unnecessarily after every inter RAT handover in that UE Radio Access Capabilities are made available in the HANDOVER TO UTRAN COMPLETE message sent by the UE. This way, UTRAN would have the full capabilities of the UE same time when inter RAT handover is completed.

In other words, according to a variation of the procedure shown in FIG. 4, exemplary details of the deciding operation and the transmitting operation are given, which are inherently independent from each other as such. Such exemplary deciding operation according to exemplary embodiments of the present invention may comprise an operation of ascertaining whether a handover completion message completing a handover is to be sent. Further, such exemplary transmitting operation according to exemplary embodiments of the present invention may comprise an operation of including said mobile device capability information in said handover completion message, and an operation of sending said handover completion message.

To make such behaviour UTRAN controllable, according to exemplary embodiments of the present invention a “Capability Update Requirement” IE is added in the HANDOVER TO UTRAN COMMAND message. When UE receives the message and sees that UTRAN has also asked to provide the UE capabilities in the HANDOVER TO UTRAN COMMAND message, the UE appends its capabilities in the HANDOVER TO UTRAN COMPLETE message.

In other words, according to a variation of the procedure shown in FIG. 4, exemplary details of the deciding operation are given, which are inherently independent from each other as such. Such exemplary deciding operation according to exemplary embodiments of the present invention may comprise an operation of receiving a handover command message, and an operation of checking whether said handover command message comprises a requirement to include said mobile device capability information in said handover completion message.

It is noted that in line with the above mentioned the abstract syntax notation number 1 (ASN.1) needs to be changed by introducing new IEs as shown below.

The thus described exemplary embodiments may require a change in message definition between the UE and the RNC.

The needed changes in the messages are described herein below.

In particular, according to exemplary embodiments of the present invention a corresponding sequence may be as follows:

Once UE receives an HANDOVER TO UTRAN COMMAND message as exemplarily shown below, UE responds to UTRAN in a HANDOVER TO UTRAN COMPLETE message as also exemplarily shown below. It is noted that of every message represented by a table firstly the complete table is shown, while subsequently a table is shown representing only the new IE(s) according to exemplary embodiments of the present invention in the respective message. The new IE(s) in the HANDOVER TO UTRAN COMPLETE message could be briefed.

### HANDOVER TO UTRAN COMPLETE Message (UE->UTRAN):

| Information Element/ | | | Type and | Semantics | |
|---|---|---|---|---|---|
| Group name | Need | Multi | reference | description | Version |
| Message Type | MP | | Message | | |
| | | | Type | | |
| UE Information elements | | | | | |
| START list | CH | 1 to | | START [40] | |
| | | <maxCNdomains> | | values for | |
| | | | | all CN domains. | |
| >CN domain identity | MP | | CN domain | | |
| | | | identity | | |
| | | | 10.3.1.1 | | |
| >START | MP | | START | | |
| | | | 10.3.3.38 | | |
| RB Information elements | | | | | |
| COUNT-C activation | OP | | Activation | Used for | |
| time | | | time | radio bearers | |
| | | | 10.3.3.1 | mapped | |
| | | | | on RLC-TM. | |
| Other Information elements | | | | | REL- |
| | | | | | 10 |
| Logged Meas Available | OP | | Enumerated | Indicates | REL- |
| | | | (TRUE) | the UE has | 10 |
| | | | | logged | |
| | | | | measurements | |
| | | | | to | |
| | | | | report to the | |
| | | | | network | |
| Connection Establishment | OP | | Enumerated | True indicates | REL- |
| Failure Info Available | | | (TRUE) | the | 11 |
| | | | | UE has | |
| | | | | logged | |
| | | | | measurements | |
| | | | | from | |
| | | | | a RRC connection | |
| | | | | establishment | |
| | | | | failure to | |
| | | | | report to the | |
| | | | | network | |
| UE radio access capability | OP | | UE radio | | REL- |
| | | | access | | 12 |
| | | | capability | | |
| | | | 10.3.3.42 | | |
| UE radio access capability | OP | | UE radio | | REL- |
| extension | | | access | | 12 |
| | | | capability | | |
| | | | extension | | |
| | | | 10.3.3.42a | | |
| Other information elements | | | | | |
| UE system specific capability | OP | 1 to <max- | | | REL- |
| | | InterSysMessages> | | | 12 |
| >Inter-RAT UE radio | MP | | Inter-RAT | | REL- |
| access capability | | | UE radio | | 12 |
| | | | access | | |
| | | | capability | | |
| | | | 10.3.8.7 | | |

### Partial HANDOVER TO UTRAN COMPLETE Message (new IE(s) Only):

| Information Element/ | | | Type and | Semantics | |
|---|---|---|---|---|---|
| Group name | Need | Multi | reference | description | Version |
| UE radio access capability | OP | | UE radio | | REL- |
| | | | access | | 12 |
| | | | capability | | |
| | | | 10.3.3.42 | | |
| UE radio access capability | OP | | UE radio | | REL- |
| extension | | | access | | 12 |
| | | | capability | | |
| | | | extension | | |
| | | | 10.3.3.42a | | |
| Other information elements | | | | | |
| UE system specific capability | OP | 1 to <max- | | | REL- |
| | | InterSysMessages> | | | 12 |
| >Inter-RAT UE radio | MP | | Inter-RAT | | REL- |
| access capability | | | UE radio | | 12 |
| | | | access | | |
| | | | capability | | |
| | | | 10.3.8.7 | | |

According to exemplary embodiments of the present invention, UTRAN could inform the UE by sending indication to send its capability.

### HANDOVER TO UTRAN COMMAND (UTRAN>UE):

| Information Element/ | | | Type and | Semantics | |
|---|---|---|---|---|---|
| Group name | Need | Multi | reference | description | Version |
| New U-RNTI | MP | | U-RNTI | | |
| | | | Short | | |
| | | | 10.3.3.48 | | |
| Ciphering algorithm | OP | | Ciphering | | |
| | | | algorithm | | |
| | | | 10.3.3.4 | | |
| Capability update requirement | MD | | Capability | Default | REL- |
| | | | update | value is | 12 |
| | | | requirement | defined in | |
| | | | 10.3.3.2 | subclause | |
| | | | | 10.3.3.2 | |
| RNC support for change | MP | | Boolean | | REL-7 |
| of UE capability | | | | | |
| New H-RNTI | OP | | H-RNTI | | REL-6 |
| | | | 10.3.3.14a | | |
| New Primary E-RNTI | OP | | E-RNTI | | REL-6 |
| | | | 10.3.3.10a | | |
| New Secondary E-RNTI | OP | | E-RNTI | FDD only | REL-6 |
| | | | 10.3.3.10a | | |
| Specification mode | | | | | REL-8 |
| information elements | | | | | |
| Default configuration for | OP | | Default | | REL-8 |
| CELL_FACH | | | configuration | | |
| | | | for | | |
| | | | CELL_FACH | | |
| | | | 10.3.4.0a | | |
| CHOICE specification | MP | | | | |
| mode | | | | | |
| >Complete specification | | | | | |
| RB information elements | | | | | |
| >>Signalling RB information | MP | 1 to | | For each | |
| to setup list | | <maxSRBset | | signalling | |
| | | up> | | radio | |
| | | | | bearer established | |
| >>>Signalling RB information | MP | | Signalling | | |
| to setup | | | RB information | | |
| | | | to | | |
| | | | setup | | |
| | | | 10.3.4.24 | | |
| >>RAB information to | OP | 1 to | | For each | |
| setup list | | <maxRAB- | | RAB established | |
| | | setup> | | | |
| >>>RAB information for | MP | | RAB information | | |
| setup | | | for setup | | |
| | | | 10.3.4.10 | | |
| Uplink transport channels | | | | | |
| >>UL Transport channel | MP | | UL Transport | | |
| information common for | | | channel | | |
| all transport channels | | | information | | |
| | | | common | | |
| | | | for all | | |
| | | | transport | | |
| | | | channels | | |
| | | | 10.3.5.24 | | |
| >>Added or Reconfigured | MP | 1 to | | | |
| TrCH information | | <maxTrCH> | | | |
| >>>Added or Reconfigured | MP | | Added or | | |
| UL TrCH information | | | Reconfigured | | |
| | | | UL | | |
| | | | TrCH information | | |
| | | | 10.3.5.2 | | |
| Downlink transport | | | | | |
| channels | | | | | |
| >>DL Transport channel | MP | | DL Transport | | |
| information common for | | | channel | | |
| all transport channels | | | information | | |
| | | | common | | |
| | | | for all | | |
| | | | transport | | |
| | | | channels | | |
| | | | 10.3.5.6 | | |
| >>Added or Reconfigured | MP | 1 to | | | |
| TrCH information | | <maxTrCH> | | | |
| >>>Added or Reconfigured | MP | | Added or | | |
| DL TrCH information | | | Reconfigured | | |
| | | | DL | | |
| | | | TrCH information | | |
| | | | 10.3.5.1 | | |
| Uplink radio resources | | | | | |
| >>Uplink DPCH info | MP | | Uplink | | |
| | | | DPCH info | | |
| | | | 10.3.6.88 | | |
| >>E-DCH Info | OP | | E-DCH | | REL-6 |
| | | | Info | | |
| | | | 10.3.6.97 | | |
| Downlink radio resources | | | | | |
| (Complete | | | | | |
| specification) | | | | | |
| >>Downlink HS-PDSCH | OP | | Downlink | | REL-6 |
| Information | | | HS- | | |
| | | | PDSCH | | |
| | | | Information | | |
| | | | 10.3.6.23a | | |
| >>Downlink information | MP | | Downlink | | |
| common for all radio | | | information | | |
| links | | | common | | |
| | | | for all | | |
| | | | radio links | | |
| | | | 10.3.6.24 | | |
| >>Downlink information | MP | 1 to <maxRL> | | | |
| per radio link | | | | | |
| >>>Downlink information | MP | | Downlink | | |
| for each radio link | | | information | | |
| | | | for | | |
| | | | each radio | | |
| | | | link | | |
| | | | 10.3.6.27 | | |
| >Preconfiguration | | | | | |
| >>CHOICE Preconfiguration | MP | | | | |
| mode | | | | | |
| >>>Predefined configuration | MP | | Predefined | NOTE 1 | |
| | | | configuration | | |
| | | | identity | | |
| | | | 10.3.4.5 | | |
| >>>Default configuration | | | | | |
| >>>>Default configuration | MP | | Enumerated | Indicates | |
| mode | | | (FDD, | whether | |
| | | | TDD) | the FDD or | |
| | | | | TDD version | |
| | | | | of the | |
| | | | | default | |
| | | | | configuration | |
| | | | | shall | |
| | | | | be used | |
| >>>>Default configuration | MP | | Default | | |
| identity | | | configuration | | |
| | | | identity | | |
| | | | 10.3.4.0 | | |
| >>RAB info | OP | | RAB info | One RAB | |
| | | | Post | is established | |
| | | | 10.3.4.9 | | |
| >>CHOICE mode | MP | | | | |
| >>>FDD | | | | | |
| >>>>Uplink DPCH info | MP | | Uplink | | |
| | | | DPCH info | | |
| | | | Post | | |
| | | | 10.3.6.89 | | |
| >>>CHOICE tdd | | | | | |
| >>>>1.28 Mcps TDD and | | | | | |
| 7.64 Mcps TDD | | | | | |
| >>>>> Uplink DPCH info | MP | | Uplink | | |
| | | | DPCH info | | |
| | | | 10.3.6.88 | | |
| Downlink radio resources | | | | | |
| (Preconfiguration) | | | | | |
| >>>>3.84 Mcps TDD | | | | | |
| >>>>>Uplink DPCH info | MP | | Uplink | | |
| | | | DPCH info | | |
| | | | Post | | |
| | | | 10.3.6.89 | | |
| >>Downlink information | MP | | Downlink | | |
| common for all radio | | | information | | |
| links | | | common | | |
| | | | for all | | |
| | | | radio links | | |
| | | | Post | | |
| | | | 10.3.6.25 | | |
| >>Downlink information | MP | 1 to <maxRL> | | Send | |
| per radio link | | | | downlink | |
| | | | | information | |
| | | | | for each | |
| | | | | radio link to | |
| | | | | be set-up. | |
| | | | | In TDD | |
| | | | | MaxRL is | |
| | | | | 1. | |
| >>>Downlink information | MP | | Downlink | | |
| for each radio link | | | information | | |
| | | | for | | |
| | | | each radio | | |
| | | | link Post | | |
| | | | 10.3.6.28 | | |
| >>CHOICE mode | MP | | | | |
| >>>FDD | | | | (no data) | |
| >>>TDD | | | | | |
| >>>>Primary CCPCH Tx | MP | | Primary | | |
| Power | | | CCPCH | | |
| | | | Tx Power | | |
| | | | 10.3.6.59 | | |
| Frequency info | MP | | Frequency | | |
| | | | info | | |
| | | | 10.3.6.36 | | |
| Multi-frequency Info | OP | | Multi- | This IE is | REL-7 |
| | | | frequency | used for | |
| | | | Info | 1.28 Mcps | |
| | | | 10.3.6.39a | TDD only | |
| Maximum allowed UL TX | MP | | Maximum | | |
| power | | | allowed | | |
| | | | UL TX | | |
| | | | power | | |
| | | | 10.3.6.39 | | |

### Partial HANDOVER TO UTRAN COMMAND (New IE(s) Only):

| Information | | | | | |
|---|---|---|---|---|---|
| Element/ | | | Type and | Semantics | |
| Group name | Need | Multi | reference | description | Version |
| Capability update | MD | | Capability | Default | REL- |
| requirement | | | update | value is | 12 |
| | | | requirement | defined in | |
| | | | 10.3.3.2 | subclause | |
| | | | | 10.3.3.2 | |

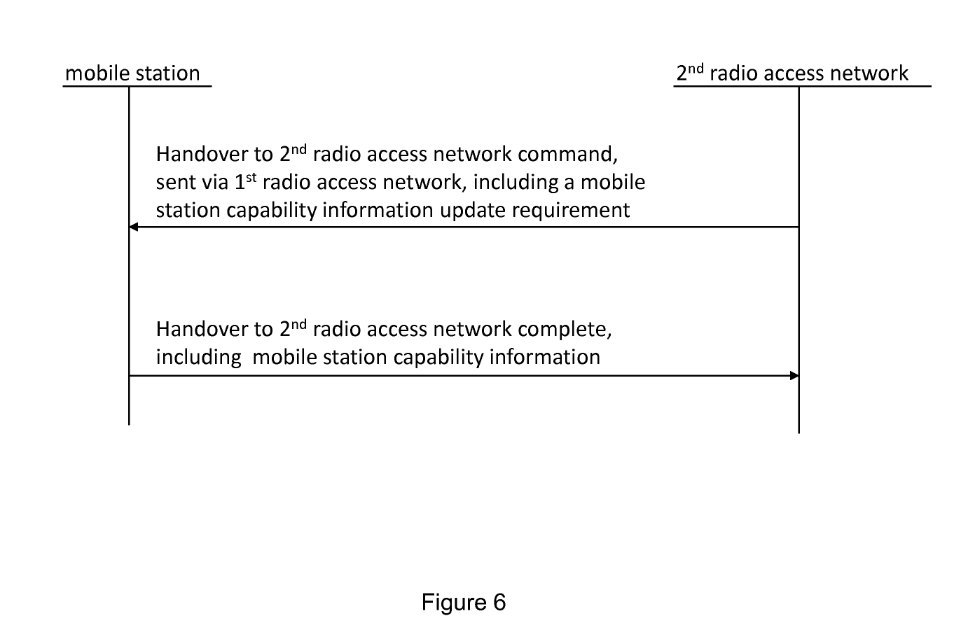

FIG. 6 shows a schematic diagram of signaling sequences according to exemplary embodiments of the present invention implementing the above mentioned alternative.

As an alternative, according to exemplary embodiments of the present invention the UE may be allowed to send UE CAPABILITY INFORMATION message by itself always after an inter RAT handover. UE may do it immediately after the handover procedure, since UE is well aware of the inter RAT handover ongoing. UTRAN should always be prepared to receive the UE Radio Access Capabilities after the inter RAT handover.

According to this alternative, no changes in the ASN.1 are required, but only procedural changes in the UE may be necessary.

Hence, according to a variation of the procedure shown in FIG. 4, exemplary details of the deciding operation and the transmitting operation are given, which are inherently independent from each other as such. Such exemplary deciding operation according to exemplary embodiments of the present invention may comprise an operation of discovering whether a handover is completed. Further, such exemplary transmitting operation according to exemplary embodiments of the present invention may comprise an operation of sending a message comprising said mobile device capability information.

The thus described exemplary embodiments may not require a change in message definition between the UE and the RNC. In particular, this alternative does not require any change in RRC messages coming from the UE.

However, as networks based on Release 11 and/or earlier may not be prepared to receive UE CAPABILITY INFORMATION during the inter RAT handover procedure, according to exemplary embodiments the UTRAN may explicitly indicate with an IE in the HANDOVER TO UTRAN COMMAND message that UE may send its capabilities after the inter RAT handover is completed. This shall trigger UE to send its capabilities as soon as it receives radio link control (RLC) acknowledgment for HANDOVER TO UTRAN COMPLETE message, or to send it some (predetermined) time after submitting HANDOVER TO UTRAN COMPLETE. This way UTRAN may know and be prepared to receive the UE Radio Access Capabilities in the UE CAPABILITY INFORMATION message immediately after the inter RAT handover.

In other words, according to a variation of the procedure shown in FIG. 4, exemplary details of the deciding operation are given, which are inherently independent from each other as such. Such exemplary deciding operation according to exemplary embodiments of the present invention may comprise an operation of receiving a handover command message, and an operation of checking whether said handover command message comprises an indication to transmit said mobile device capability information after said handover is completed.

According to a further variation of the procedure shown in FIG. 4, exemplary details of the discovering operation are given, which are inherently independent from each other as such. Such exemplary discovering operation according to exemplary embodiments of the present invention may comprise an operation of detecting whether a an acknowledgement of a handover completion message completing a handover is received, and/or an operation of detecting whether a predetermined period of time is elapsed from transmission of said handover completion message.

To allow UTRAN to continue with further signalling, UE does not need to start timer T304 in this case, though this can be made optional. The benefit of not starting the timer T304 in this case is that the UE has transferred its capability first time to the UTRAN, so it does not need to treat it as changed capability and thus there is no need to wait for UE CAPABILITY INFORMATION CONFIRM from the network. Also UTRAN can then continue with the remaining procedures which have to be completed as soon as the inter RAT handover has been completed.

The thus described exemplary embodiments may require a change in message definition between the UE and the RNC. In particular, for the possibility of network controlling the UE to send its capability, or for any other reason the network wants not to have this always, the new IE in the HANDOVER TO UTRAN COMMAND as defined above may be used. A repetition thereof is omitted for the sake of clarity.

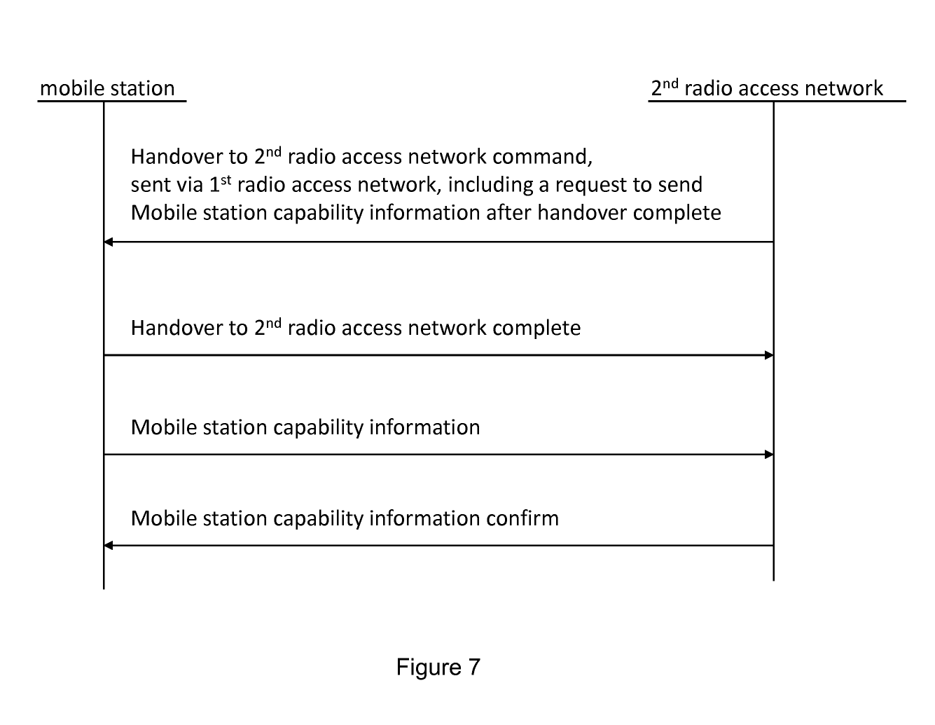

FIG. 7 shows a schematic diagram of signaling sequences according to exemplary embodiments of the present invention implementing the above mentioned alternative.

As a further alternative besides the above mentioned more UE based alternatives, according to exemplary embodiments of the present invention a more network based alternative is provided, which may not require any changes in the UEs specification or implementation. According to exemplary embodiments, a new IE is added in the “Inter RAT Handover Info” IE in the RELOCATION REQUEST to indicate to RNC that full capabilities of the UE have not been transferred.

Then UTRAN knows that it needs to ask the UE Radio Access Capabilities after the inter RAT handover procedure is completed. If this new IE is absent in the “Inter RAT Handover Info” IE, then network considers that UE has sent information about all its capabilities, and that thus there is no need to ask about the UE Radio Access Capabilities through a UE CAPABILITY ENQUIRY, such that corresponding time and signalling can be saved.

In other words, according to a variation of the procedure shown in FIG. 4, exemplary details of the deciding operation and the transmitting operation are given, which are inherently independent from each other as such. Such exemplary deciding operation according to exemplary embodiments of the present invention may comprise an operation of detecting whether a capability enquiry is received. Further, such exemplary transmitting operation according to exemplary embodiments of the present invention may comprise an operation of sending a message comprising said mobile device capability information in response to said capability enquiry.

The thus described exemplary embodiments may require a change in message definition between the source RNC and the target RNC.

The needed changes in the messages are described herein below.

In particular, according to exemplary embodiments of the present invention changes in the RELOCATION REQUEST message or inside the RRC Container in the RELOCATION REQUEST message are necessary to indicate RNC that UE capabilities have been omitted. This way, UTRAN will at least know that it needs to enquire UE Capabilities only in these cases and not always. The new IE could be included inside IE “Source RNC To Target RNC Transparent Container” or also in the RELOCATION REQUEST. The new IE is preferably included in the “Source RNC To Target RNC Transparent Container” IE as exemplarily shown below and may be enumerated or boolean type value. It is noted that the “Source RNC To Target RNC Transparent Container” IE is represented by a table, where firstly the complete table is shown, while subsequently a table is shown representing only the new IE(s) according to exemplary embodiments of the present invention in the respective message.

### “Source RNC to Taraet RNC Transparent Container”:

| IE/Group | | | IE type | | | Assigned |
|---|---|---|---|---|---|---|
| Name | Presence | Range | and reference | Semantics description | Criticality | Criticality |
| RRC | M | | OCTET | | — | |
| Container | | | STRING | | | |
| Number | M | | INTEGER | | — | |
| of lu | | | (1 . . . 2) | | | |
| Instances | | | | | | |
| Relocation | M | | 9.2.1.23 | | — | |
| Type | | | | | | |
| Chosen | O | | 9.2.1.13 | Indicates the | — | |
| Integrity | | | | integrity protection | | |
| Protection | | | | algorithm. | | |
| Algorithm | | | | | | |
| Integrity | O | | Bit String | | — | |
| Protection | | | (128) | | | |
| Key | | | | | | |
| Chosen | O | | 9.2.1.14 | Indicates the | — | |
| Encryption | | | | algorithm for | | |
| Algorithm | | | | ciphering of signailing | | |
| | | | | data. | | |
| Ciphering | O | | Bit String | | — | |
| Key | | | (128) | | | |
| Chosen | O | | 9.2.1.14 | Indicates the | — | |
| Encryption | | | | algorithm for | | |
| Algorithm | | | | ciphering of CS | | |
| | | | | user data. | | |
| Chosen | O | | 9.2.1.14 | Indicates the | — | |
| Encryption | | | | algorithm for | | |
| Algorithm | | | | ciphering of PS | | |
| | | | | user data. | | |
| d-RNTI | C-ifUE- | | INTEGER | | — | |
| | notinvolved | | (0 . . . 1048575) | | | |
| Target | C-ifUE- | | INTEGER | This information | — | |
| Cell ID | involved | | (0 . . . 268435455) | element identifies | | |
| | | | | a cell | | |
| | | | | uniquely within | | |
| | | | | UTRAN and | | |
| | | | | consists of | | |
| | | | | RNC-ID and C- | | |
| | | | | ID as defined in | | |
| | | | | TS 25.401 [3] or | | |
| | | | | Cell Identity IE | | |
| | | | | as defined in TS | | |
| | | | | 25.331[10] if the | | |
| | | | | target is a HNB | | |
| | | | | TS 25.467 [55]. | | |
| Cell | O | | 9.2.1.60 | For “Cell Load- | — | |
| Load | | | | Based Inter- | | |
| Information | | | | System Hand- | | |
| Group | | | | over”. | | |
| RAB | O | 1 to | | | — | |
| TrCH | | <max- | | | | |
| Mapping | | noofRABs> | | | | |
| >RAB | M | | 9.2.1.2 | | — | |
| ID | | | | | | |
| >RAB | M | 1 to | | The RAB Sub- | — | |
| Sub- | | <maxRAB- | | flows shall be | | |
| flow | | Sub- | | presented in an | | |
| | | flows> | | order that corresponds | | |
| | | | | to the | | |
| | | | | order in which | | |
| | | | | the RBs are | | |
| | | | | presented per | | |
| | | | | RAB in the RRC | | |
| | | | | container included | | |
| | | | | in this IE. | | |
| >>Transport | | | | | — | |
| Channel | | | | | | |
| IDs | | | | | | |
| >>>DCH | O | | INTEGER | The DCH ID is | — | |
| ID | | | (0 . . . 255) | the identifier of | | |
| | | | | an active dedicated | | |
| | | | | transport | | |
| | | | | channel. It is | | |
| | | | | unique for each | | |
| | | | | active DCH | | |
| | | | | among the active | | |
| | | | | DCHs simultaneously | | |
| | | | | allocated for the | | |
| | | | | same UE. | | |
| >>>DSCH | O | | INTEGER | The DSCH ID is | — | |
| ID | | | (0 . . . 255) | the identifier of | | |
| | | | | an active | | |
| | | | | downlink shared | | |
| | | | | transport channel. | | |
| | | | | It is unique | | |
| | | | | for each DSCH | | |
| | | | | among the active | | |
| | | | | DSCHs simultaneously | | |
| | | | | allocated for the | | |
| | | | | same UE. | | |
| >>>USCH | O | | INTEGER | The USCH ID is | — | |
| ID | | | (0 . . . 255) | the identifier of | | |
| | | | | an active uplink | | |
| | | | | shared transport | | |
| | | | | channel. It is | | |
| | | | | unique for each | | |
| | | | | USCH among | | |
| | | | | the active | | |
| | | | | USCHs simultaneously | | |
| | | | | allocated | | |
| | | | | for the | | |
| | | | | same UE. | | |
| >>>HS- | O | | INTEGER | The HS-DSCH | YES | ignore |
| DSCH | | | (0 . . . 7) | MAC-d Flow ID | | |
| MAC-d | | | | is the identifier | | |
| Flow ID | | | | of an HS-DSCH | | |
| | | | | MAC-d flow over | | |
| | | | | lur. | | |
| >>>E- | O | | INTEGER | The E-DCH | YES | ignore |
| DCH | | | (0 . . . 7) | MAC-d Flow ID | | |
| MAC-d | | | | is the identifier | | |
| Flow ID | | | | of an E-DCH | | |
| | | | | MAC-d flow over | | |
| | | | | lur. | | |
| >CN | M | | 9.2.1.5 | | YES | ignore |
| Domain | | | | | | |
| Indicator | | | | | | |
| SRB | O | 1 to | | | GLOBAL | reject |
| TrCH | | <max- | | | | |
| Mapping | | noofSRBs> | | | | |
| >SRB | M | | INTEGER | The SRB ID is | — | |
| ID | | | (1 . . . 32) | the absolute | | |
| | | | | value of the | | |
| | | | | SRB. | | |
| >DCH | O | | INTEGER | The DCH ID is | — | |
| ID | | | (0 . . . 255) | the identifier of | | |
| | | | | an active dedicated | | |
| | | | | transport | | |
| | | | | channel over | | |
| | | | | lur. It is unique | | |
| | | | | for each active | | |
| | | | | DCH among the | | |
| | | | | active DCHs | | |
| | | | | simultaneously | | |
| | | | | allocated for the | | |
| | | | | same UE. | | |
| >DSCH | O | | INTEGER | The DSCH ID is | — | |
| ID | | | (0 . . . 255) | the identifier of | | |
| | | | | an active | | |
| | | | | downlink shared | | |
| | | | | transport channel | | |
| | | | | over lur. It is | | |
| | | | | unique for each | | |
| | | | | DSCH among | | |
| | | | | the active | | |
| | | | | DSCHs simultaneously | | |
| | | | | allocated | | |
| | | | | for the | | |
| | | | | same UE. | | |
| >USCH | O | | INTEGER | The USCH ID is | — | |
| ID | | | (0 . . . 255) | the identifier of | | |
| | | | | an active uplink | | |
| | | | | shared transport | | |
| | | | | channel over | | |
| | | | | lur. It is unique | | |
| | | | | for each USCH | | |
| | | | | among the active | | |
| | | | | USCHs simultaneously | | |
| | | | | allocated for the | | |
| | | | | same UE. | | |
| >HS- | O | | INTEGER | The HS-DSCH | YES | ignore |
| DSCH | | | (0 . . . 7) | MAC-d Flow ID | | |
| MAC-d | | | | is the identifier | | |
| Flow ID | | | | of an HS-DSCH | | |
| | | | | MAC-d flow over | | |
| | | | | lur. | | |
| >E-DCH | O | | INTEGER | The E-DCH | YES | ignore |
| MAC-d | | | (0 . . . 7) | MAC-d Flow ID | | |
| Flow ID | | | | is the identifier | | |
| | | | | of an E-DCH | | |
| | | | | MAC-d flow over | | |
| | | | | lur. | | |
| Trace | O | | 9.2.1.66 | | YES | ignore |
| Recording | | | | | | |
| Session | | | | | | |
| Information | | | | | | |
| MBMS | O | | ENUMERATED | | YES | ignore |
| Linking | | | (UE-has- | | | |
| Information | | | joined- | | | |
| | | | Multicast- | | | |
| | | | Services, . . . ) | | | |
| d-RNTI | O | | INTEGER | | YES | reject |
| for No | | | (0 . . . 1048575) | | | |
| luCS | | | | | | |
| UP | | | | | | |
| UE History | O | | OCTET | Defined in TS | YES | ignore |
| Information | | | STRING | 36.413 [49]. | | |
| Subscriber | O | | 9.2.1.86 | | YES | ignore |
| Profile | | | | | | |
| ID for | | | | | | |
| RAT/Frequency | | | | | | |
| priority | | | | | | |
| SRVCC | O | | 9.2.1.89 | Included only incase | YES | reject |
| Information | | | | of intra- | | |
| | | | | UMTS SRVCC. | | |
| PS RAB | O | | RAB ID | Included only incase | YES | reject |
| To Be | | | 9.2.1.2 | of intra- | | |
| Replaced | | | | UMTS SRVCC. | | |
| CSFB | O | | ENUMERATED | | YES | ignore |
| Information | | | (CSFB, | | | |
| | | | CSFB | | | |
| | | | High Priority, . . . ) | | | |
| IRAT | O | | 9.2.1.96 | | YES | ignore |
| Measurement | | | | | | |
| Configuration | | | | | | |
| Management | O | | 9.2.1.110 | | YES | ignore |
| Based | | | | | | |
| MDT | | | | | | |
| Allowed | | | | | | |
| Management | O | | MDT | | YES | ignore |
| Based | | | PLMN | | | |
| MDT | | | List | | | |
| PLMN | | | 9.2.1.116 | | | |
| List | | | | | | |
| UE Capability | O | | ENUMERATED | | YES | ignore |
| Update | | | (TRUE) | | | |
| Required | | | | | | |

### Partial “Source RNC to Taraet RNC Transparent Container” IE (New IE(s) Only):

| IE/Group | | | IE type | | | Assigned |
|---|---|---|---|---|---|---|
| Name | Presence | Range | and reference | Semantics description | Criticality | Criticality |
| UE Capability | O | | ENUMERATED | | YES | ignore |
| Update | | | (TRUE) | | | |
| Required | | | | | | |

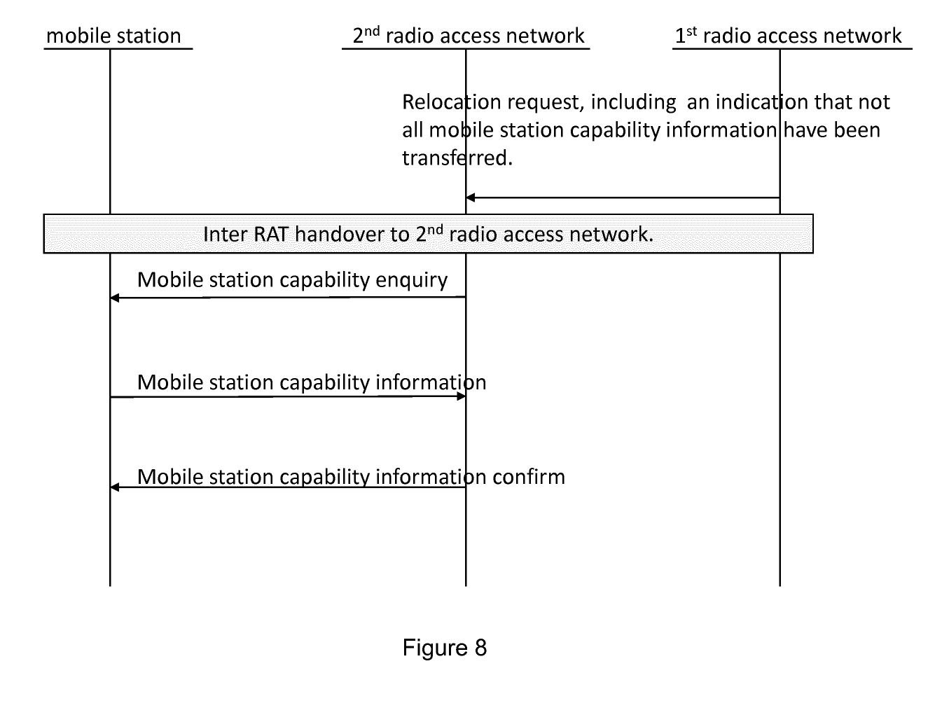

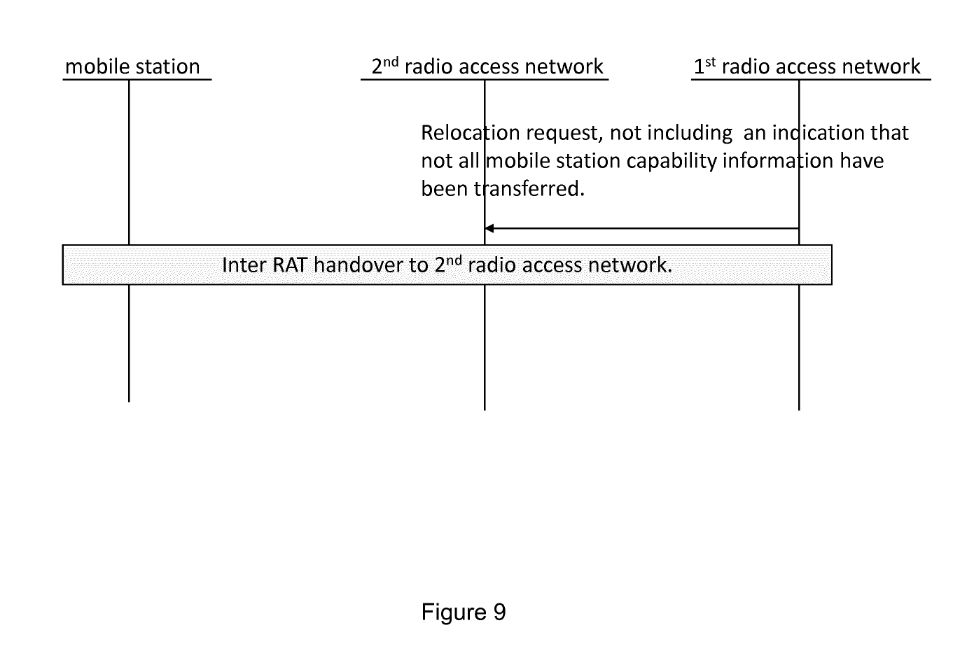

FIGS. 8 and 9 show schematic diagrams of signaling sequences according to exemplary embodiments of the present invention implementing the above mentioned alternative. It is derivable from those Figures that, when the indication that not all mobile station capability information have been transferred (i.e. “UE Capability Update Required” IE) is contained in the relocation request, the UTRAN knows that the capability information is incomplete and enquires the same. On the other hand, when the indication that not all mobile station capability information have been transferred (i.e. “UE Capability Update Required” IE) is not contained in the relocation request, the UTRAN knows that the capability information is complete and does not enquire the same.

It is noted that according to exemplary embodiments the above described alternatives may be combined so that they co-exist and such that it is then up to UE and UTRAN implementation which one is used. It is further noted that it is possible according to exemplary embodiments that when UTRAN knows through the above mentioned more network based alternative that UE capabilities have to be enquired, it indicates UE using one of the above mentioned more UE based alternatives to send its capabilities with the HANDOVER TO UTRAN COMPLETE or after the HANDOVER TO UTRAN COMPLETE messages.

That is, for optimal signalling, combination of the more network based alternative with either of the more UE based alternatives may be used according to exemplary embodiments of the present invention.

Since the latter more UE based alternative requires only UE support to read the new IE in the HANDOVER TO UTRAN COMMAND, it may be preferred. The latter more UE based alternative may, however, also be used alone by the UE.

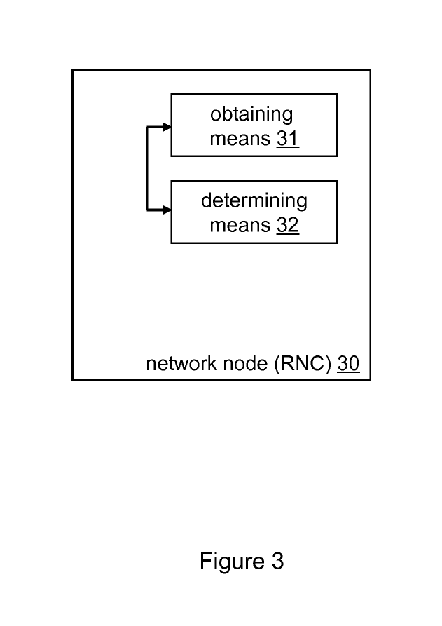

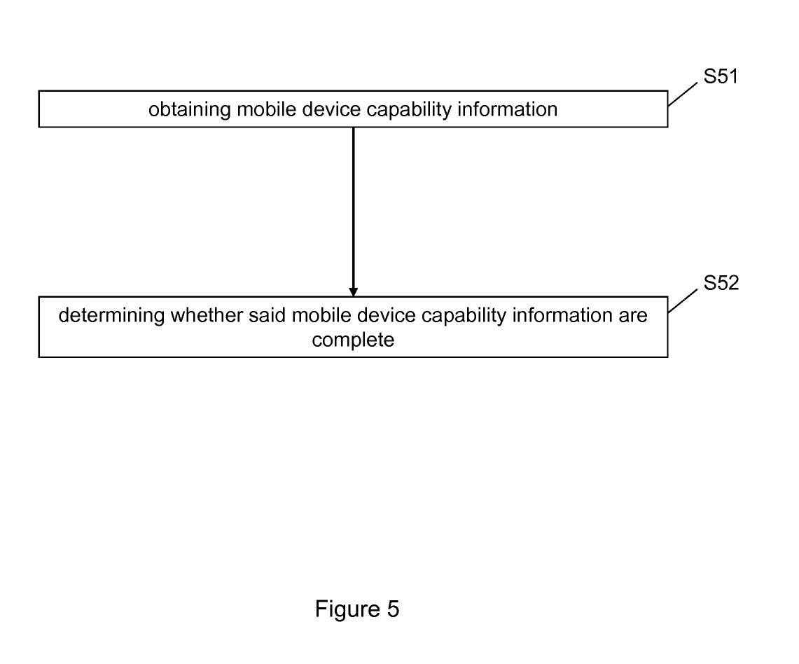

FIG. 3 is a block diagram illustrating an apparatus according to exemplary embodiments of the present invention. The apparatus may be an access node 30 such as a base station comprising an obtaining means 31 and a determining means 32. The obtaining means 31 obtains mobile device capability information. The determining means 32 determines whether said mobile device capability information is complete. FIG. 5 is a schematic diagram of a procedure according to exemplary embodiments of the present invention. The apparatus according to FIG. 3 may perform the method of FIG. 5 but is not limited to this method. The method of FIG. 5 may be performed by the apparatus of FIG. 3 but is not limited to being performed by this apparatus.

As shown in FIG. 5, a procedure according to exemplary embodiments of the present invention comprises an operation of obtaining (S51) mobile device capability information, and an operation of determining (S52) whether said mobile device capability information is complete.

According to a variation of the procedure shown in FIG. 5, exemplary details of the determining operation are given, which are inherently independent from each other as such. Such exemplary determining operation according to exemplary embodiments of the present invention may comprise an operation of receiving a handover completion message completing a handover, and an operation of deciding that said mobile device capability information is complete is said mobile device capability information is included in said handover completion message.

According to a variation of the procedure shown in FIG. 5, exemplary additional operations are given, which are inherently independent from each other as such. According to such variation, an exemplary method according to exemplary embodiments of the present invention may comprise an operation of transmitting a handover command message comprising a requirement to include said mobile device capability information in said handover completion message.

According to a variation of the procedure shown in FIG. 5, exemplary details of the obtaining operation and the determining operation are given, which are inherently independent from each other as such. Such exemplary obtaining operation according to exemplary embodiments of the present invention may comprise an operation of receiving a message comprising said mobile device capability information. Such exemplary determining operation according to exemplary embodiments of the present invention may comprise an operation of deciding that said mobile device capability information is complete if said message is received after a handover is completed.

According to a variation of the procedure shown in FIG. 5, exemplary additional operations are given, which are inherently independent from each other as such. According to such variation, an exemplary method according to exemplary embodiments of the present invention may comprise an operation of transmitting a handover command message comprising an indication to transmit said mobile device capability information after said handover is completed.

According to a variation of the procedure shown in FIG. 5, it is assumed that said handover is completed if an acknowledgement of a handover completion message completing a handover is transmitted, and/or if a predetermined period of time is elapsed from receipt of said handover completion message.

According to a variation of the procedure shown in FIG. 5, exemplary details of the obtaining operation and the determining operation are given, which are inherently independent from each other as such. Such exemplary obtaining operation according to exemplary embodiments of the present invention may comprise an operation of receiving a relocation request message comprising said mobile device capability information. Such exemplary determining operation according to exemplary embodiments of the present invention may comprise an operation of deciding, that said mobile device capability information is not complete, if said relocation request message comprises an incompleteness information, said incompleteness information indicating that said mobile device capability information is not in full included in said relocation request message, and an operation of deciding, that said mobile device capability information is complete, if said relocation request message does not comprise said incompleteness information.

Alternatively, according to a variation of the procedure shown in FIG. 5, exemplary details of the obtaining operation and the determining operation are given, which are inherently independent from each other as such. Such exemplary obtaining operation according to exemplary embodiments of the present invention may comprise an operation of receiving a relocation request message comprising said mobile device capability information. Such exemplary determining operation according to exemplary embodiments of the present invention may comprise an operation of deciding, that said mobile device capability information is complete, if said relocation request message comprises an completeness information, said completeness information indicating that said mobile device capability information is in full included in said relocation request message, and an operation of deciding, that said mobile device capability information is not complete, if said relocation request message does not comprise said completeness information.

Alternatively, according to a variation of the procedure shown in FIG. 5, exemplary details of the obtaining operation and the determining operation are given, which are inherently independent from each other as such. Such exemplary obtaining operation according to exemplary embodiments of the present invention may comprise an operation of transmitting, if it is decided that said mobile device capability information is not complete, a capability enquiry, and an operation of receiving a message comprising said mobile device capability information. Such exemplary determining operation according to exemplary embodiments of the present invention may comprise an operation of deciding that said mobile device capability information is complete if said message is received in response to said capability enquiry.

Alternatively, according to a variation of the procedure shown in FIG. 5, exemplary additional operations are given, which are inherently independent from each other as such. According to such variation, an exemplary method according to exemplary embodiments of the present invention may further comprise an operation of adding incompleteness information to a relocation request message, if said mobile device capability information is not in full included in said relocation request message, said incompleteness information indicating that said mobile device capability information is not in full included in said relocation request message, an operation of prohibiting addition of said incompleteness information, if said mobile device capability information is in full included in said relocation request message, and an operation of transmitting said relocation request message.

As a further alternative, according to a further variation of the procedure shown in FIG. 5, exemplary additional operations are given, which are inherently independent from each other as such. According to such variation, an exemplary method according to exemplary embodiments of the present invention may further comprise an operation of adding completeness information to a relocation request message, if said mobile device capability information is in full included in said relocation request message, said completeness information indicating that said mobile device capability information is in full included in said relocation request message, an operation of prohibiting addition of said completeness information, if said mobile device capability information is not in full included in said relocation request message, and an operation of transmitting said relocation request message.

The latter described further alternative embodiments may require a change in message definition between the source RNC and the target RNC, which may be similar to the change as shown above in relation with FIG. 4, i.e., a change in the “Source RNC To Target RNC Transparent Container” IE. The skilled person is aware that in such case the additional IE in the “Source RNC To Target RNC Transparent Container” IE may be named “UE Capability Update NOT Required” IE or similar, which may of the same type as the “UE Capability Update Required” IE mentioned above. For the sake of clarity, however, a repetition of the whole IE is omitted.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into subblocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

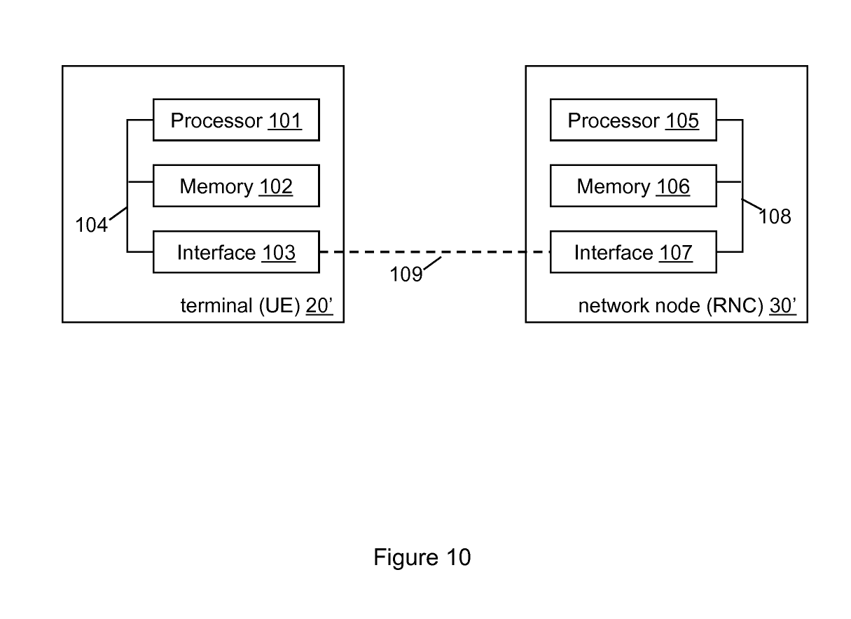

In FIG. 10, an alternative illustration of apparatuses according to exemplary embodiments of the present invention is depicted. As indicated in FIG. 10, according to exemplary embodiments of the present invention, the apparatus (terminal) 20′ (corresponding to the terminal 20) comprises a processor 101, a memory 102 and an interface 103, which are connected by a bus 104 or the like. Further, according to exemplary embodiments of the present invention, the apparatus (network node) 30′ (corresponding to the network node 30) comprises a processor 105, a memory 106 and an interface 107, which are connected by a bus 108 or the like, and the apparatuses may be connected via link 109, respectively.

The processor 101/105 and/or the interface 103/107 may also include a modem or the like to facilitate communication over a (hardwire or wireless) link, respectively. The interface 103/107 may include a suitable transceiver coupled to one or more antennas or communication means for (hardwire or wireless) communications with the linked or connected device(s), respectively. The interface 103/107 is generally configured to communicate with at least one other apparatus, i.e. the interface thereof.

The memory 102/106 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the terminal 20 comprises at least one processor 101, at least one memory 102 including computer program code, and at least one interface 103 configured for communication with at least another apparatus. The processor (i.e. the at least one processor 101, with the at least one memory 102 and the computer program code) is configured to perform deciding whether mobile device capability information is to be transmitted (thus the apparatus comprising corresponding means for deciding, and to perform transmitting, based on affirmative result of said deciding, said mobile device capability information (thus the apparatus comprising corresponding means for transmitting).

According to exemplary embodiments of the present invention, an apparatus representing the network node 30 comprises at least one processor 105, at least one memory 106 including computer program code, and at least one interface 107 configured for communication with at least another apparatus. The processor (i.e. the at least one processor 105, with the at least one memory 106 and the computer program code) is configured to perform obtaining mobile device capability information (thus the apparatus comprising corresponding means for obtaining, and to perform determining whether said mobile device capability information is complete (thus the apparatus comprising corresponding means for determining).

For further details regarding the operability/functionality of the individual apparatuses, reference is made to the above description in connection with any one of FIGS. 2 to 9, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for capability handling after inter radio access technology handover. Such measures exemplarily comprise deciding whether mobile device capability information is to be transmitted, and transmitting, based on affirmative result of said deciding, said mobile device capability information.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3^{rd} Generation Partnership Project
ASN.1 abstract syntax notation number 1
FDD frequency division duplex
IE information element
NW network element
RAT radio access technology
RLC radio link control
RNC radio network controller
RRC radio resource control
TS technical specification
TDD time division duplex
UTRAN Universal Terrestrial Radio Access Network
UE user equipment

1. A method comprising
deciding whether mobile device capability information is to be transmitted, and
transmitting, based on affirmative result of said deciding, said mobile device capability information.

2. The method according to claim 1, wherein
in relation to said deciding, said method further comprises
ascertaining whether a handover completion message completing a handover is to be sent, and
in relation to said transmitting, said method further comprises
including said mobile device capability information in said handover completion message, and
sending said handover completion message.

3. The method according to claim 2, wherein
in relation to said deciding, said method further comprises
receiving a handover command message, and
checking whether said handover command message comprises a requirement to include said mobile device capability information in said handover completion message.

4. The method according to claim 1, wherein
in relation to said deciding, said method further comprises
discovering whether a handover is completed, and
in relation to said transmitting, said method further comprises sending a message comprising said mobile device capability information.

5. The method according to claim 4, wherein
in relation to said deciding, said method further comprises
receiving a handover command message, and
checking whether said handover command message comprises an indication to transmit said mobile device capability information after said handover is completed.

6. The method according to claim 4, wherein
in relation to said discovering, said method further comprises
detecting whether an acknowledgement of a handover completion message completing a handover is received, and/or
detecting whether a predetermined period of time is elapsed from transmission of said handover completion message.

7. The method according to claim 1, wherein
in relation to said deciding, said method further comprises
detecting whether a capability enquiry is received, and
in relation to said transmitting, said method further comprises
sending a message comprising said mobile device capability information in response to said capability enquiry.

8-18. (canceled)

19. An apparatus comprising
deciding means configured to decide whether mobile device capability information is to be transmitted, and
transmitting means configured to transmit, based on affirmative result of said deciding, said mobile device capability information.

20. The apparatus according to claim 19, further comprising
ascertaining means configured to ascertain whether a handover completion message completing a handover is to be sent,
including means configured to include said mobile device capability information in said handover completion message, and
sending means configured to send said handover completion message.

21. The apparatus according to claim 20, further comprising receiving means configured to receive a handover command message, and checking means configured to check whether said handover command message comprises a requirement to include said mobile device capability information in said handover completion message.

22. The apparatus according to claim 19, further comprising
discovering means configured to discover whether a handover is completed, and
sending means configured to send a message comprising said mobile device capability information.

23. The apparatus according to claim 22, further comprising
receiving means configured to receive a handover command message, and
checking means configured to check whether said handover command message comprises an indication to transmit said mobile device capability information after said handover is completed.

24. The apparatus according to claim 22, further comprising
detecting means configured to detect
whether an acknowledgement of a handover completion message completing a handover is received, and/or
whether a predetermined period of time is elapsed from transmission of said handover completion message.

25. The apparatus according to claim 19, further comprising
detecting means configured to detect whether a capability enquiry is received, and
sending means configured to send a message comprising said mobile device capability information in response to said capability enquiry.

26. The apparatus according to claim 19, wherein
the apparatus is operable as or at a terminal, user equipment, mobile station or modem, and/or
the apparatus is operable in at least one of a LTE and a LTE-A cellular system.

27-38. (canceled)

39. A computer program product comprising computer-executable computer program code which, when the program is run on a computer, is configured to cause the computer to carry out the method according to claim 1.

40. The computer program product according to claim 39, wherein the computer program product comprises a computer-readable medium on which the computer-executable computer program code is stored, and/or wherein the program is directly loadable into an internal memory of the processor.
